(19) United States
(12) Patent Application Publication
(10) Pub. No.: US 2016/0260564 A1
(43) Pub. Date: Sep. 8, 2016

(54) ELECTROMAGNETIC CONTACTOR

(71) Applicant: FUJI ELECTRIC FA COMPONENTS & SYSTEMS CO., LTD., Tokyo (JP)

(72) Inventors: Takashi TSUTSUMI, Kouosu (JP); Masaaki WATANABE, Kouosu (JP); Hideki DAIJIMA, Kouosu (JP); Shota SHIINOKI, Kouosu (JP)

(73) Assignee: FUJI ELECTRIC FA COMPONENTS & SYSTEMS CO., LTD., Tokyo (JP)

(21) Appl. No.: 15/159,284

(22) Filed: May 19, 2016

Related U.S. Application Data
(63) Continuation of application No. PCT/JP2015/001946, filed on Apr. 7, 2015.

(30) Foreign Application Priority Data
May 20, 2014 (JP) 2014-104748

(51) Int. Cl. H01H 50/30; H01H 50/44

(52) U.S. Cl. CPC H01H 50/30; H01H 50/443

(57) ABSTRACT

An electromagnetic contactor in which a shock-absorbing member is integrally formed in a frame. The electromagnetic contactor includes a first frame in which an operating electromagnet is disposed and coil terminals which supply power to a coil of the electromagnet is formed to project from a side surface, and a second frame in which a contact mechanism having an auxiliary contact is disposed and has power source side terminals on one end side and load side terminals on the other end side, and in the first frame and the second frame, a snap fit is formed which can attach the second frame to the first frame in both of a normal direction coupled state where the coil terminals and the power source side terminals face the same direction and a reverse direction coupled state in which the coil terminals and the load side terminals face the same direction.

### CROSS-REFERENCE TO RELATED APPLICATIONS

This application is a continuation application filed under 35 U.S.C. §111(a), of International Application PCT/JP2015/001946, filed Apr. 7, 2015, and claims foreign priority benefit to Japanese Patent Application No. 2014-104748, filed May 20, 2014, the contents of which are incorporated herein by reference.

### TECHNICAL FIELD

The present invention relates to an electromagnetic contactor including an operating electromagnet having a fixed core and a movable core, more particularly to an electromagnetic contactor which absorbs shock when a movable core collides with a fixed core.

### BACKGROUND ART

As an electromagnetic contactor including this type of operating electromagnet, for example, a conventional example described in Patent Literature 1 is known.

In Patent Literature 1, a fixed core is disposed via an elastic member made of a shock-absorbing rubber in a fixed insulating base, and the fixed core is positively moved toward a movable core during driving by an electromagnetic coil, thereby decreasing a relative collision speed to improve mechanical durability of the movable core and the fixed core.

### CITATION LIST

### Patent Literature

PTL 1: JP 2010-282834 A

### SUMMARY OF INVENTION

### Technical Problem

However, in a conventional example described in Patent Literature 1 mentioned above, an elastic member made of a shock-absorbing rubber disposed in a bottom portion of a fixed insulating base is disposed as a shock-absorbing material, and hence there are unsolved problems that the shock-absorbing material is separately required, the number of components increases, and manufacturing cost also increases.

Thus, the present invention has been developed in view of the unsolved problems of the above conventional example, and an object thereof is to provide an electromagnetic contactor in which a shock-absorbing member is integrally formed in a frame, whereby a shock-absorbing effect can be exerted while decreasing the number of components.

### Solution to Problem

To achieve the above object, one configuration of an electromagnetic contactor according to the present invention includes a first frame and a second frame which are made of a synthetic resin and coupled with each other, an operating electromagnet in which a fixed core is fixed in the first frame and a movable core is disposed in the second frame, and a shock-absorbing rib integrally formed in a bottom portion of a bottomed tubular section of the first frame to support the fixed core of the operating electromagnet.

### Advantageous Effects of Invention

According to the present invention, a shock-absorbing rib which supports a fixed core is formed in a bottom portion of a first frame, and hence a separate shock-absorbing member does not have to be disposed between the fixed core and the bottom portion of the first frame, and a shock-absorbing effect can be exerted while decreasing the number of components.

### BRIEF DESCRIPTION OF DRAWINGS

FIG. 1 is an appearance perspective view illustrative of an electromagnetic contactor according to the present invention;

FIG. 2 is a transverse cross-sectional view of FIG. 1;

FIG. 3 is a front view of a first frame;

FIG. 4 is a front view in which a fixed core of the first frame is attached;

FIG. 5 is a front view in which a spool of the first frame is attached;

FIG. 6 is a perspective view of the first frame;

FIG. 7 is a vertical cross-sectional view of the first frame;

FIG. 8 is an enlarged perspective view illustrative of shock-absorbing ribs of the first frame;

FIGS. 9A to 9C are views illustrative of a second frame, FIG. 9A is a front view, FIG. 9B is a side view, and FIG. 9C is a back view; and

FIG. 10 is an exploded perspective view illustrative of the electromagnetic contactor of FIG. 1.

### DESCRIPTION OF EMBODIMENTS

One embodiment of the present invention will now be described with reference to the drawings.

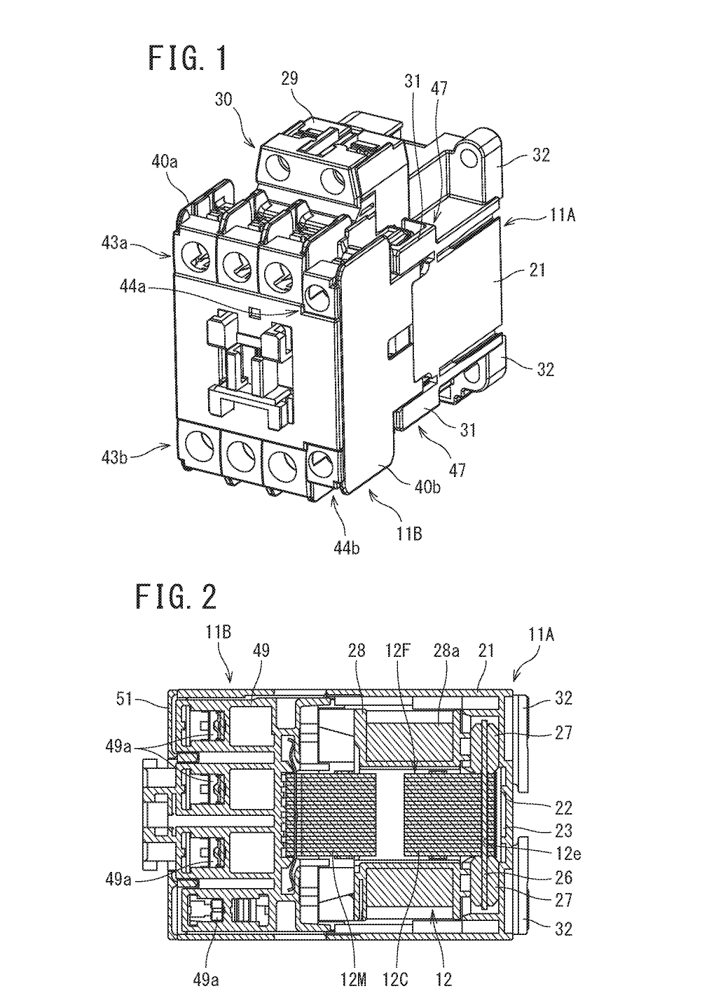

As illustrated in FIG. 1, an electromagnetic contactor 10 according to the present invention is constituted a first frame 11A and a second frame 11B which are made of a synthetic resin material such as polybutylene terephthalate (PBT) and coupled with each other.

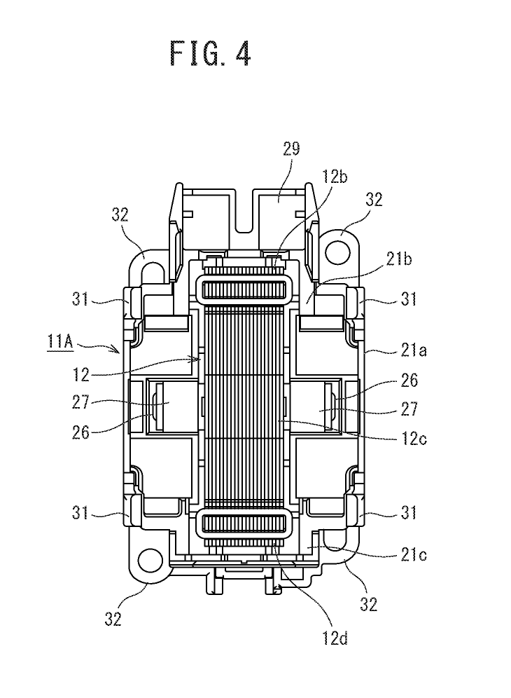

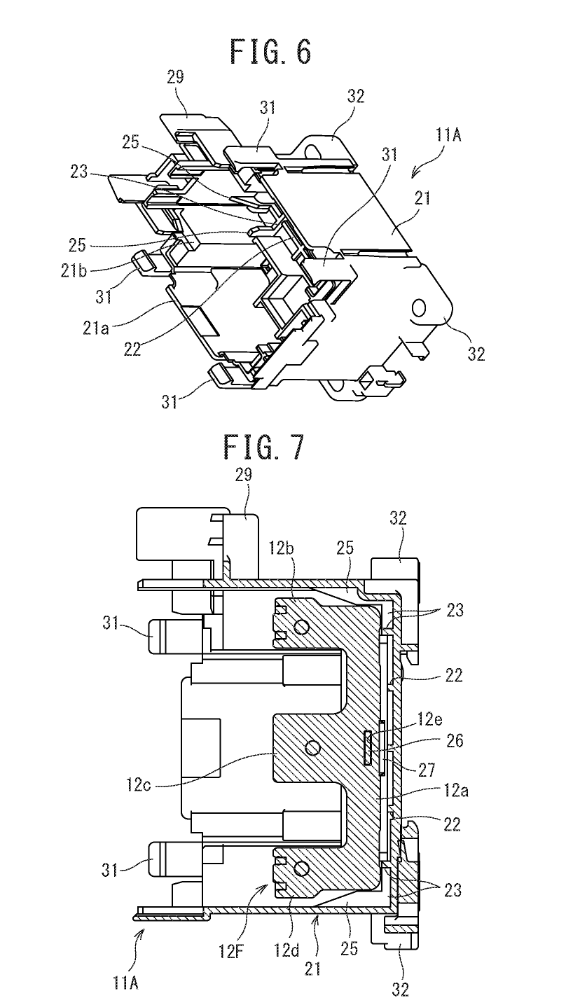

In the first frame 11A, as illustrated in FIG. 2, FIG. 4 and FIG. 6, an operating electromagnet 12 is disposed. In the second frame 11B, as illustrated in FIG. 2, there is disposed a contact mechanism 13 driven to be on and off by the operating electromagnet 12.

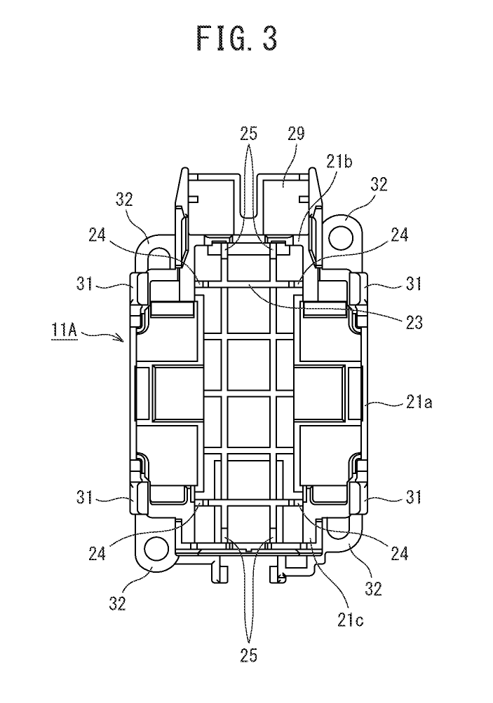

The first frame 11A has a bottomed square tubular section 21 containing the operating electromagnet 12. As seen from a front and illustrated in FIG. 3, the bottomed square tubular section 21 is constituted of a wide portion 21a of a central portion, and narrow portions 21b and 21c disposed on one pair of facing side walls, for example, upper and lower side walls of the wide portion 21a and formed vertically linearly symmetrically based on a central axis of an upward-downward direction of the wide portion 21a to communicate with the wide portion 21a. Further, on a bottom surface between the narrow portion 21b and the narrow portion 21c between which the wide portion 21a is sandwiched, latticed reinforcing ribs 22 which reinforce a bottom plate portion of the bottomed square tubular section 21 are integrally formed.

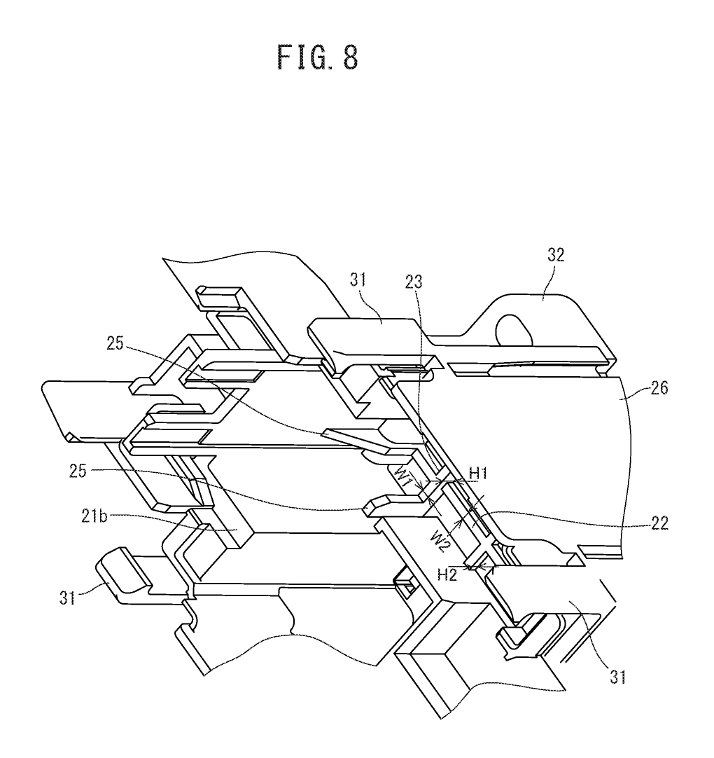

Ribs extending in a right-left direction on upper and lower end portion sides of the reinforcing ribs 22 are defined as shock-absorbing ribs 23 which support a fixed core 12F of the operating electromagnet 12. As illustrated in FIG. 6 and FIG. 8, a width W1 of the shock-absorbing ribs 23 is set to be smaller than a width W2 of the other reinforcing ribs 22 and a height H1 of the shock-absorbing ribs is set to be higher than a height H2 of the other reinforcing ribs 22. Consequently, the shock-absorbing ribs 23 are constituted to be easy to bend, thereby exerting a shock-absorbing function as compared with the reinforcing ribs 22. Additionally, guide members 24 which project forward to guide the fixed core 12F are integrally formed in right and left end portions of the shock-absorbing ribs 23, and guide members 24 which guide the fixed core 12F are also integrally formed in upper and lower end portion sides of the shock-absorbing ribs.

Further, the fixed core 12F constituting the operating electromagnet 12 is supported on the shock-absorbing ribs 23. As illustrated in FIG. 7, the fixed core 12F has an E-shape by forming projecting portions 12b to 12d in an upper end portion, a central portion and a lower end portion of a coupling plate portion 12a extending in the upward-downward direction.

In the fixed core 12F, a support plate 26 is inserted into a through hole 12e formed at a position that faces the central projecting portion 12c of the coupling plate portion 12a, and both right and left end portions of the support plate 26 which project from the coupling plate portion 12a are inserted into elastic members 27, respectively, as illustrated in FIG. 2.

As illustrated in FIG. 2, the elastic members 27 are sandwiched between a spool 28 which is attached to a periphery of the central projecting portion 12c of the fixed core 12F and around which an energization coil 28a is wound and the bottom portion of the bottomed square tubular section 21.

Therefore, a central portion of the fixed core 12F is elastically supported by the elastic members 27 via the support plate 26, and upper and lower end portions of the fixed core in a longitudinal direction are elastically supported by the shock-absorbing ribs 23.

Additionally, the spool 28 is integrally formed with a coil terminal 30 fixed to a terminal base 29 projecting out from one narrow portion 21b of the first frame 11A.

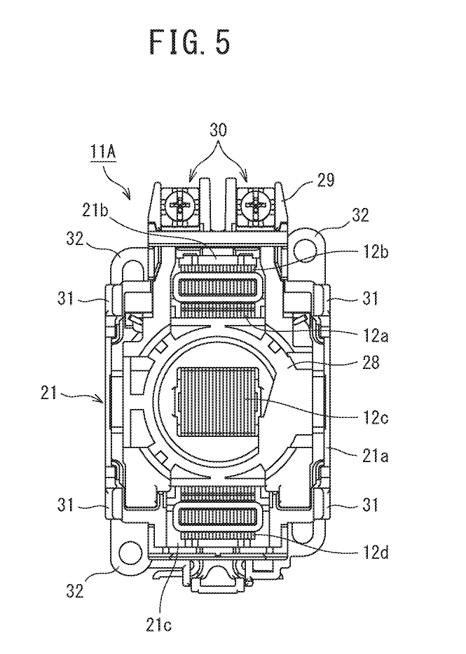

Furthermore, at front ends of the other pair of facing side walls, for example, right and left side walls of the wide portion 21a of the first frame 11A, as illustrated in FIG. 3 to FIG. 7, four hook portions 31 extending forward from both end portions of the narrow portions 21b and 21c are formed at symmetric positions in the upward-downward direction and a forward-backward direction so that engaging portions 31a are turned inside.

Furthermore, attaching plate portions 32 having attaching holes are formed at four corners of the bottom portion of the bottomed square tubular section 21 of the first frame 11A.

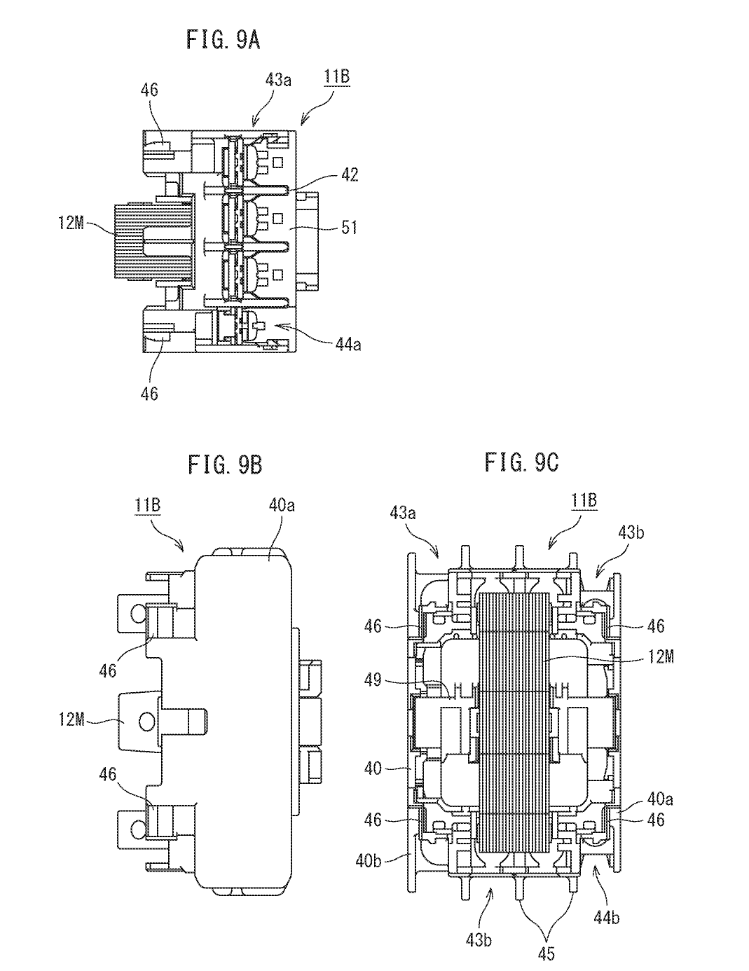

As illustrated in FIGS. 9(a) to (c), the second frame 11B includes a square tubular portion 40 in which a shape of a coupling portion side to be coupled with the first frame 11A has the same shape as in the bottomed square tubular section 21 of the first frame 11A. The square tubular portion 40 has a wide portion 41a and narrow portions 41b and 41c which communicate with the wide portion 41a in the same manner as in the bottomed square tubular section 21.

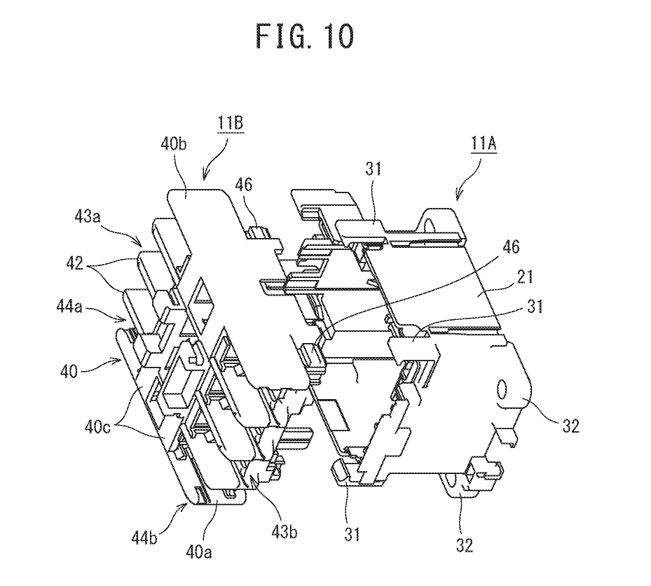

Additionally, in the square tubular portion 40, as illustrated in FIG. 10, facing side surface plate portions 40a and 40b in which the narrow portions 41b and 41c do not communicate extend on aside opposite to the coupling portion side. Coupling plate portions 40c bridge a space between central portions of extending end portions of the facing side surface plate portions 40a and 40b. On lower sides of the coupling plate portions 40c, there are formed plural, e.g., three partition walls 42 which divide a space between the facing side surface plate portions 40a and 40b in parallel so that a main circuit power source side terminal portion 43a and an auxiliary terminal portion 44a are disposed.

Additionally, on upper sides of the coupling plate portions 40c, there are formed plural, e.g., three partition walls 45 which divide a space between the facing side surface plate portions 40a and 40b in parallel so that a main circuit load side terminal portion 43b and an auxiliary terminal portion 44b are disposed.

Furthermore, in the facing side surface plate portions 40a and 40b, engaging projections 46 with which engaging portions 31b of the hook portions 31 engage from the outside are formed at four positions facing the hook portions 31 of the first frame 11A, respectively.

Further, the hook portions 31 formed in the first frame 11A and the engaging projections 46 formed in the second frame 11B constitute snap fits 47.

Additionally, an arc-extinguishing chamber 48 is formed on a back surface side of the coupling plate portions 40c, a contact holder 49 that holds movable contacts 49a is held to be slidable in the forward-backward direction in the arc-extinguishing chamber 48, a movable core 12M that faces the fixed core 12F is coupled with the back surface side of the contact holder 49, and a non-illustrated return spring is disposed between the movable core 12M and the spool 28 of the first frame 11A.

Furthermore, an arc-extinguishing cover 51 is disposed to cover upper surfaces, front surfaces and lower surfaces of the coupling plate portions 40c.

Further, as illustrated in FIG. 1, the first frame 11A and the second frame 11B are integrated in a state where the hook portions 31 of the first frame 11A are engaged with the engaging projections 46 of the second frame 11B.

Next, an operation of the above embodiment will be described.

Now, it is defined that an AC power source is connected to the main circuit power source side terminal portion 42a of the electromagnetic contactor 10 and that, for example, a three-phase electric motor is connected to the main circuit load side terminal portion 42b.

At this time, when the energization coil 28a wound around the spool 28 of the operating electromagnet 12 is in a non-energized state, as illustrated in FIG. 2, the movable core 12M is held at a front position by the non-illustrated return spring to be disposed away from the fixed core 12F.

In this state, the contact holder 49 coupled with the movable core 12M moves forward to move the movable contacts 49a away from a fixed contact (not illustrated), thereby making a power supply cut-off state between the main circuit power source side terminal portion 43a and the main circuit load side terminal portion 43b.

When power supply is started from this power supply cut-off state to the energization coil 28a wound around the spool 28 of the operating electromagnet 12, a large suction force is generated in the fixed core 12F, and this suction force brings the movable core 12M into collision with the fixed core 12F against the return spring (not illustrated).

At this time, the central portion of the fixed core 12F is elastically supported by the elastic members 27 via the support plate 26, the upper and lower end portions of the fixed core are elastically supported by the shock-absorbing ribs 23, and hence an impact force when the movable core 12M collides with the fixed core is relaxed by the elastic members 27 and the shock-absorbing ribs 23.

In this way, when the movable core 12M collides with the fixed core 12F, the contact holder 49 coupled with the movable core 12M moves backward, the movable contacts 49a come in contact with the fixed contact (not illustrated) to make an energized state in the main circuit power source side terminal portion 43a and the main circuit load side terminal portion 43b, and power is supplied to the three-phase electric motor.

Afterward, in a case where the three-phase electric motor is stopped, the power supply to the coil terminal 30 is stopped, thereby eliminating the suction force of the fixed core 12F. In consequence, the movable core 12M is returned to the front position illustrated in FIG. 2 by the return spring (not illustrated), and the movable contacts 49a move forward away from the fixed contact (not illustrated) to return to the power supply cut-off state.

Consequently, according to the above embodiment, the shock-absorbing ribs 23 which elastically support the upper and lower end portions of the fixed core 12F are formed in the bottom portion of the bottomed square tubular section 21 of the first frame 11A, and hence, to make the energized state, the impact force when the fixed core 12F sucks the movable core 12M to bring the movable core 12M into collision with the fixed core 12F can be relaxed by the elastic members 27 in the central portion of the fixed core 12F and relaxed by the shock-absorbing ribs 23 in the upper and lower end portions of the fixed core 12F.

In this case, the shock-absorbing ribs 23 are integrally formed in the bottom portion of the bottomed square tubular section 21 of the first frame 11A, an elastic member made of a shock-absorbing rubber as in the abovementioned conventional example does not have to be separately disposed, and a shock-absorbing effect can be exerted while decreasing the number of components.

Additionally, the shock-absorbing ribs 23 are integrally formed in the bottomed square tubular section 21, and hence an operation of attaching the elastic member made of the shock-absorbing rubber is not required, and the number of assembling steps can be decreased.

Additionally, the shock-absorbing ribs 23 are formed as parts of the reinforcing ribs 22 which reinforce the bottom portion of the bottomed square tubular section 21, and hence as compared with a case where shock-absorbing ribs for exclusive use are formed, integral formation can easily be carried out without noticeably changing a die.

Furthermore, the guide members 24 and 25 which guide the fixed core 12F are formed around the shock-absorbing ribs 23, and hence the fixed core 12F can be positioned so that the upper and lower end portions of the fixed core securely come in contact with the shock-absorbing ribs 23.

It is to be noted that in the above respective embodiments, there has been described the case where the first frame 11A has the bottomed square tubular section 21, but the section does not have to be square tubular, and corner portions may be circular or the section may be formed into an optional tubular shape such as a cylindrical shape or an elliptic tubular shape.

Additionally, in the above respective embodiments, there has been described the case where the hook portions 31 of the snap fits 47 are formed in the first frame 11A and the engaging projections 46 are formed in the second frame 11B, but the present invention is not limited to this case, and the engaging projections 46 may be formed in the first frame 11A and the hook portions 31 may be formed in the second frame 11B.

Additionally, in the above embodiment, there has been described the case where the electromagnetic contactor has the auxiliary terminal portions 44a and 44b, but the present invention is not limited to this case, and the present invention is also applicable to an electromagnetic contactor in which the auxiliary terminal portions 44a and 44b are omitted.

### REFERENCE SIGNS LIST

10 . . . electromagnetic contactor, 11A . . . first frame, 11B . . . second frame, 12 . . . operating electromagnet, 12F . . . fixed core, 12M . . . movable core, 13 . . . contact mechanism, 21 . . . bottomed square tubular section, 22 . . . reinforcing rib, 23 . . . shock-absorbing rib, 24 and 25 . . . guide member, 26 . . . support plate, 27 . . . elastic member, 28 . . . spool, 29 . . . terminal base, 30 . . . coil terminal, 31 . . . hook portion, 40 . . . square tubular portion, 43a . . . main circuit power source side terminal portion, 43b . . . main circuit load side terminal portion, 44a and 44b . . . auxiliary terminal portion, 46 . . . engaging projection, 47 . . . snap fit, 49 . . . contact holder, 49a . . . movable contact, and 51 . . . arc-extinguishing cover.

1. An electromagnetic contactor comprising:
a first frame and a second frame which are made of a synthetic resin and coupled with each other;
an operating electromagnet in which a fixed core is fixed in the first frame and a movable core is disposed in the second frame; and
a shock-absorbing rib integrally formed in a bottom portion of a bottomed tubular section of the first frame to support the fixed core of the operating electromagnet.

2. The electromagnetic contactor according to claim 1,
wherein the shock-absorbing ribs are formed to individually support both end sides of the fixed core in a longitudinal direction.

3. The electromagnetic contactor according to claim 1,
wherein the shock-absorbing rib is configured to be a part of reinforcing rib which reinforces a bottom plate portion of the bottomed tubular section, a width of the shock-absorbing rib is set to be narrower than a width of reinforcing rib excluding the shock-absorbing rib, and a height of the shock-absorbing rib is set to be higher than a height of the reinforcing rib excluding the shock-absorbing rib.

4. The electromagnetic contactor according to any one of claim 1,
wherein a guide member which guides the fixed core is formed around the shock-absorbing rib at a time of attaching the fixed core.

5. The electromagnetic contactor according to claim 2,
wherein the shock-absorbing rib is configured to be a part of reinforcing rib which reinforces a bottom plate portion of the bottomed tubular section, a width of the shock-absorbing rib is set to be narrower than a width of reinforcing rib excluding the shock-absorbing rib, and a height of the shock-absorbing rib is set to be higher than a height of the reinforcing rib excluding the shock-absorbing rib.

6. The electromagnetic contactor according to any one of claim 2,
wherein a guide member which guides the fixed core is formed around the shock-absorbing rib at a time of attaching the fixed core.

7. The electromagnetic contactor according to any one of claim 3,
wherein a guide member which guides the fixed core is formed around the shock-absorbing rib at a time of attaching the fixed core.
